(19) United States
(12) Patent Application Publication
(10) Pub. No.: US 2006/0088204 A1
(43) Pub. Date: Apr. 27, 2006

(54) Cleaner with security function and travel device with security function

(75) Inventor: Akitaka Shimizu, Osaka (JP)

Correspondence Address: YOKOI & CO. U.S.A., INC., 13700 MARINA POINTE DRIVE #723, MARINA DEL RAY, CA, 90292, US

(73) Assignee: Funai Electric Co., Ltd., Osaka (JP)

(21) Appl. No.: 11/252,395

(22) Filed: Oct. 18, 2005

(30) Foreign Application Priority Data
Oct. 20, 2004 (JP) JP2004-305736

(51) Int. Cl. G06K 9/00

(52) U.S. Cl. 382/153

(57) ABSTRACT

Disclosed herein is a travel device with a security function, which can always monitor a suspicious person. When charging of a battery is performed, electric power supplied from a charger device is supplied to both the buttery and a suspicious person-detecting section, and four pyroelectric sensors of the suspicious person-detecting section are activated during the charging of the battery and perform detection of a suspicious person. Thus, it is possible to detect a suspicious person during the charging and it is therefore possible to always monitor the suspicious person.

### BACKGROUND OF THE INVENTION

1. Field of the Invention

The present invention relates to a cleaner and a travel device, each of which is provided with a driving mechanism responsible for steering and driving of the cleaner (or travel device) and a security function for detecting a suspicious person.

2. Description of the Prior Art

Hitherto, there is known a travel device with a security function, which is provided with a driving mechanism responsible for steering and driving of the travel device and can perform detection of a suspicious person while self-traveling along a preset route (e.g., Japanese Patent Application Laid-Open Nos. 2002-92761, 2002-342851 and 2004-38761).

Incidentally, such travel devices with security functions as to be discussed above can detect suspicious persons while self-traveling, so that they are mostly operated by batteries that are provided inside bodies of the travel devices as power sources. Therefore, the travel device needs to be appropriately subjected to charging while being connected through the body to a charger device or the like that is set on a wall.

However, the body of the travel device with the security function is large-sized and the travel device needs to carry a battery having a large capacity in a case where power consumption for self-travel of the travel device is increased. Ina case where the battery having the large capacity is employed, it takes considerable time to charge the battery. Therefore, there is a problem that when a suspicious person intrudes during the charging of the battery, electric power is not supplied to the security function for detecting the suspicious person, resulting in the security function being unable to monitor the suspicious person.

### SUMMARY OF THE INVENTION

The present invention has been made in view of the foregoing problem. It is an object of the present invention to provide a travel device with a security function, which can always monitor a suspicious person.

In order to attain the above-mentioned object, in accordance with an embodiment of this invention, there is provided a travel device with a security function, comprising a driving mechanism responsible for steering and driving of the travel device, a suspicious person-detecting section for detecting a suspicious person, and a battery for supplying electric power to the driving mechanism and suspicious person-detecting section, the battery being adapted to be subjected to charging by an external charger device, wherein the electric power supplied from the charger device is supplied to the battery and the suspicious person-detecting section upon the charging of the battery, whereby the suspicious person-detecting section is activated during the charging of the battery.

The travel device with the security function according to the present invention, which is constructed as discussed above is provided with the driving mechanism responsible for the steering and driving of the travel device, the suspicious person-detecting section for detecting a suspicious person and the battery for supplying electric power to the driving mechanism and the suspicious person-detecting section, the battery being adapted to be charged by the external charger device.

When the charging of the battery is performed, the electric power supplied from the charger-device is supplied to both the battery and the suspicious person-detecting section, whereby the suspicious person-detecting section is activated during the charging of the battery. With the above-mentioned construction, it is possible to detect a suspicious person even if the battery is under charging, thus always enabling monitoring of the suspicious person.

In another embodiment of the present invention, the suspicious person-detecting section comprises a human sensor.

In this embodiment constructed as described above, it is possible to detect a suspicious person who is present at a position that is spaced apart from a body of the travel device with the security function at a predetermined distance.

In still another embodiment of the present invention, the travel device is provided with a camera that can pick up an image of a suspicious person.

In this embodiment constructed as described above, it is possible to pick up a figure of a suspicious person, thus enabling specifying of the suspicious person.

In yet another embodiment of the present invention, the travel device is provided with a suspicious person's image picking-up section and is such designed that when the suspicious person-detecting section detects a suspicious person during the charging of the battery, the travel device is traveled in such a manner that connection between the travel device and the charger device is interrupted, and thereafter the driving of the travel device is controlled in such a manner that the travel device is turned so as to allow the suspicious person to come within an image picking-up range of the camera, and the suspicious person's image picking up section then picks up the image of the suspicious person.

In this embodiment constructed as described above, even if the body of the travel device with the security function is connected to the charger device during charging of the battery, the body is controlled so as to be operatively spaced away from the charger device and turned toward the position where the suspicious person is present. Thus, it is possible to positively pick up the image of the suspicious person.

In still another embodiment of the present invention, the travel device is provided with a battery-monitoring section for detecting a residual amount of the battery and is such designed that the suspicious person's image picking-up section is activated when the residual amount of the battery that is detected by the battery-monitoring section exceeds a predetermined level.

In this embodiment of the present invention, it is possible to prevent the residual amount of the battery from being consumed while the suspicious person's image picking-up section of the travel device is once separated from the charger device and picks up the image of the suspicious person.

In yet another embodiment of the present invention, the travel device is provided with a cleaner mechanism.

In this embodiment of the present invention that is constructed as described above, the travel device is traveled by the driving mechanism. Therefore, it is unnecessary for a user to perform cleaning of a room while carrying the cleaner. Thus, this embodiment can reduce the user's burden. The travel device with the security function according to this embodiment is provided with the cleaner mechanism, so that power consumption of the travel device is increased, a battery that has a large capacity is therefore required, and it takes considerable time to charge the battery. However, effects that enable the monitoring of a suspicious person during charging of the battery can be sufficiently obtained.

### BRIEF DESCRIPTION OF THE DRAWINGS

The above object, other objects and many of the attendant advantages of the present invention will be readily appreciated as the same becomes better understood by reference to the following detailed description when considered in connection with the accompanying drawings, in which like reference designators denote like or corresponding parts throughout, wherein:

FIG. 1 is a perspective view showing an appearance of a self-propelled cleaner according to the present invention;

FIG. 2 is a bottom view of the self-propelled cleaner shown in FIG. 1;

FIG. 3 is a block diagram illustrating a construction of the self-propelled cleaner shown in FIGS. 1 and 2;

FIG. 4 is a block diagram illustrating a construction of a cleaning/security section shown in FIG. 3;

FIG. 5 is a flowchart exhibiting a procedure for control during charging that is performed in the self-propelled cleaner according to the present invention;

FIG. 6 is a flowchart exhibiting a procedure for a suspicious person's image picking-up process that is performed according to a call at a step S150 of the flowchart shown in FIG. 5;

FIG. 7 is a view illustrating a state of the self-propelled cleaner at the time of performing detection of a suspicious person during charging of the self-propelled cleaner;

FIG. 8 is a view showing a state of the self-propelled cleaner at the time of separating from a charger device; and

FIG. 9 is a view illustrating a state where a CCD camera is directed to a suspicious person.

### DESCRIPTION OF THE PREFERRED EMBODIMENTS

Now, embodiments of the present invention will be discussed hereinafter in the following order:

(1) an appearance of a self-propelled cleaner;

(2) an internal construction of the self-propelled cleaner;

(3) an operation of the self-propelled cleaner;

(4) various variants; and

(5) summary.

(1) The Appearance of the Self-Propelled Cleaner:

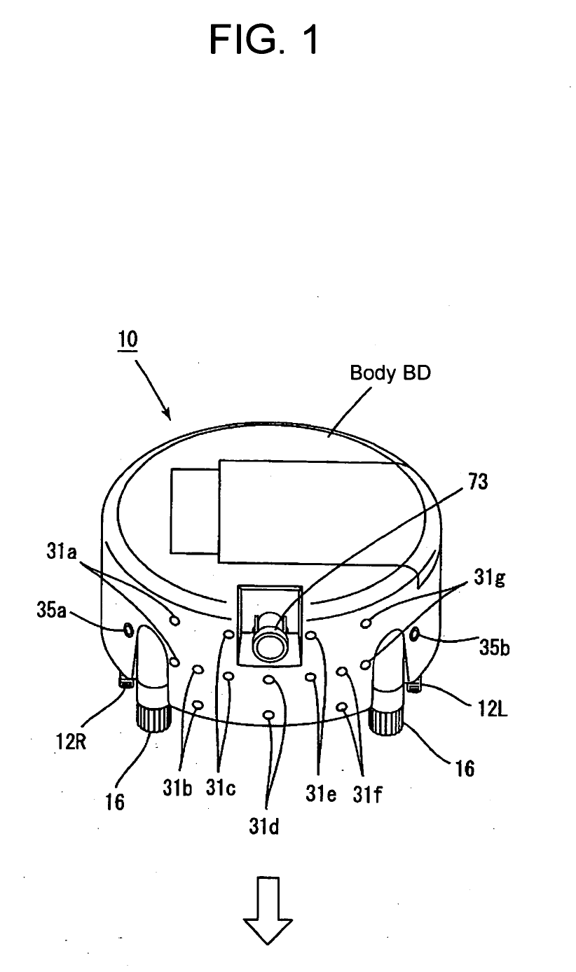

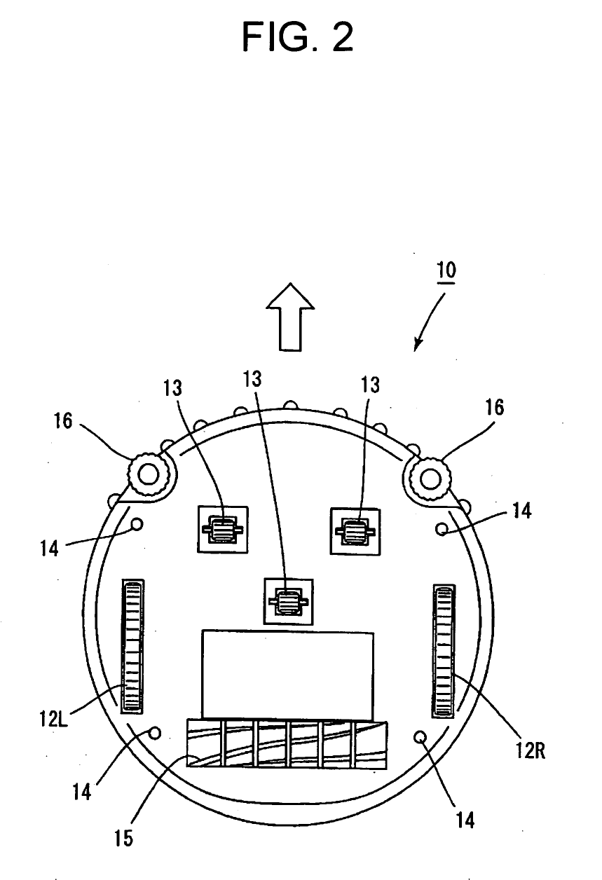

Embodiments of the present invention will be discussed hereinafter. Incidentally, while a case where a travel device with a security function according to the present invention is a self-propelled cleaner that comprises a suspicious person-detecting section, a driving mechanism and a cleaner mechanism will be discussed hereinafter, the present invention is not limited to such a self-propelled cleaner. The travel device according to the present invention may not be provided with the cleaner mechanism. FIG. 1 is a perspective view showing the appearance of the self-propelled cleaner according to the present invention. FIG. 2 is a bottom view of the self-propelled cleaner shown in FIG. 1. Incidentally, a direction indicated in FIG. 1 by an arrow A is a traveling direction of the self-propelled cleaner at the time of straight-ahead traveling. As shown in FIG. 1, the self-propelled cleaner 10 according to the present invention includes a body BD of a substantially cylindrical shape and two drive wheels 12R, 12L (see FIG. 2) provided at a bottom side of the self-propelled cleaner. By driving of the drive wheels 12R, 12L separately, the self-propelled cleaner 10 can be straightly advanced, moved back and turned. Furthermore, at a center portion of a front side of the body BD, a CCD camera 73 serving as an image picking-up sensor is provided. The CCD camera 73 is adapted to be capable of picking up an image of a suspicious person who is present in front of the body BD, and other images.

Furthermore, seven ultrasonic sensors 31 (31a-31g) acting as distance-measuring means are provided at a portion of the body BD which is lower than the CCD camera 73. The ultrasonic sensors 31 comprise dispatching sections for generating supersonic waves and receiver sections for receiving the supersonic waves that are provided by the dispatching sections, reflected by a forward wall and then returned. The ultrasonic sensors 31 are adapted to be capable of calculating a distance between the self-propelled cleaner and the wall from time that is required between the providing of the supersonic waves by the dispatching sections and the receiving of the supersonic waves by the receiver sections. Of the seven ultrasonic sensors 31, the ultrasonic sensor 31d is provided at the center portion of the front side of the body BD, the ultrasonic sensors 31a, 31g are symmetrically arranged at a left side and a right side, respectively, the ultrasonic sensors 31b, 31f are symmetrically arranged at the left side and the right side, respectively, and the ultrasonic sensors 31c, 31e are symmetrically arranged at the left side and right side, respectively. When the traveling direction of the body BD is perpendicular to the forward wall, distances that are calculated by the ultrasonic sensors 31 symmetrically arranged at the left and right sides are all same.

Furthermore, pyroelectric sensors 35 (35a, 35b) serving as human sensors are provided at the left side and right side of the front side of the body BD, respectively. The pyroelectric sensors 35a, 35b can sense infrared rays generated from the human body and detect the human who is present in the vicinity of the body BD. Incidentally, though not shown in FIG. 1, pyroelectric sensors 35 (35c, 35d) are also provided at the left and right sides of a rear side of the body BD, respectively. Thus, a sensing range of 360 degrees around the body BD can be obtained by the pyroelectric sensors 35. Incidentally, the human sensors that are employed in the present invention are not limited to the pyroelectric sensors. For example, as the human sensors, there may be employed any suitable sensors that sense infrared rays which are generated from the human body and have peculiar wavelengths.

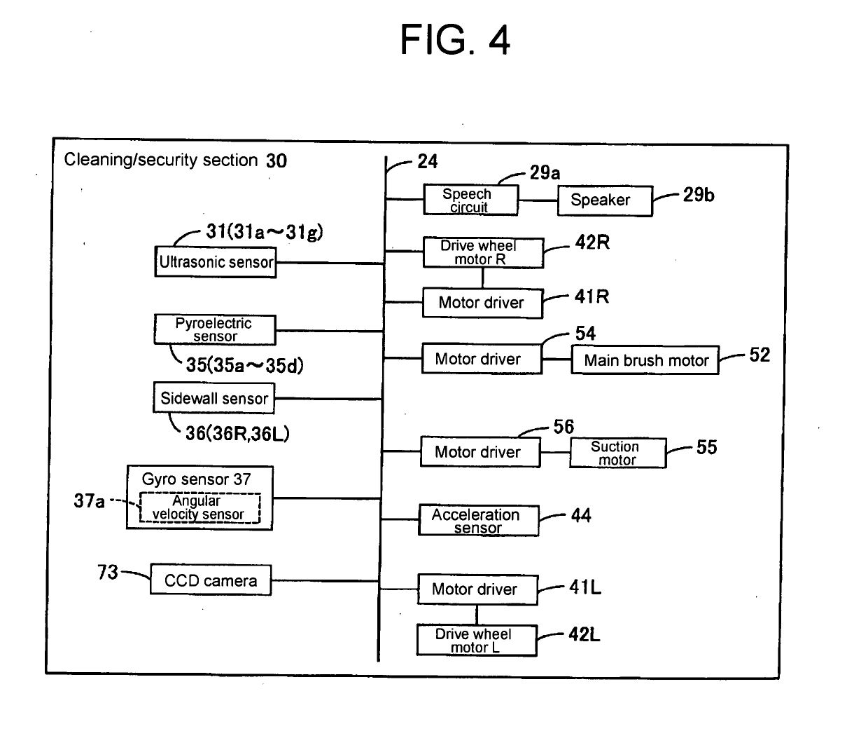

As shown in FIG. 2, the two drive wheels 12R, 12L are provided at the left and right sides of the bottom of the body BD, respectively. Furthermore, three supplementary wheels 13 are provided at a forward side of the bottom of the body BD (on the side of the traveling direction). Furthermore, step sensors 14 for detecting unevenness of a floor surface and steps of the floor surface are provided at the upper right-hand region, the lower right-hand region, the upper left-hand region and the lower left-hand region of the bottom of the body BD. A main brush 15 is provided at a region of the bottom of the body that is lower than the center portion of the bottom of the body BD. The main brush 15 is driven by a main brush motor 52 (see FIG. 4) and can sweep dirt and/or dust on the floor surface. An opening in a portion of the body BD to which the main brush 15 is attached is a suction inlet. The dirt and/or dust is sucked into the suction inlet while being swept by the main brush 15. Furthermore, side brushes 16 are provided at the upper right-hand region and the upper left-hand region of the bottom of the body BD, respectively.

(2) The Internal Construction of the Self-Propelled Cleaner:

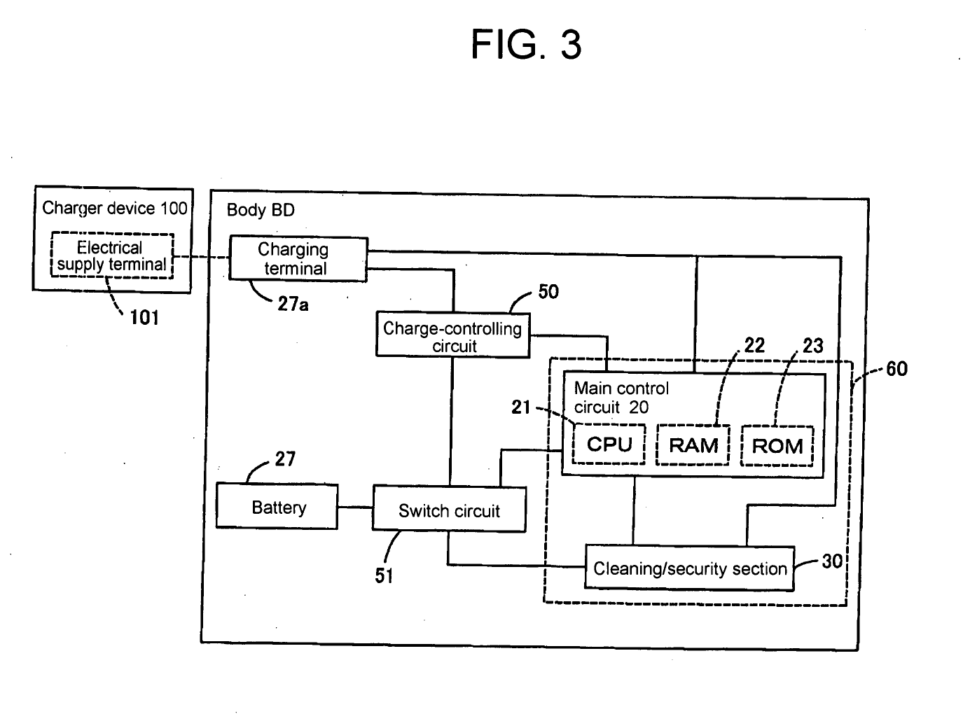

FIG. 3 is a block diagram illustrating a construction of the self-propelled cleaner shown in FIGS. 1 and 2. As shown in FIG. 3, the self-propelled cleaner 10 is provided with a charging terminal 27a that is to be operatively connected to an electrical supply terminal 101 provided at a charger device 100. Incidentally, the self-propelled cleaner 10 according to the illustrated embodiment is provided with the charging terminal 27a at the rear side of the body BD. The charger device 100 is to be set on a wall of a room. Therefore, in a state where the charging terminal 27a is connected to the electrical supply terminal 101, the CCD camera 73 is directed to such a direction as to be opposite to the wall.

The charging terminal 27a is electrically connected to a charge-controlling circuit 50. This charge-controlling circuit 50 is electrically connected to a battery 27 through a switch circuit 51 that will be discussed hereinafter. The charge-controlling circuit 50 is adapted to control an electric current supplied from the charger device 100 to the battery 27, adapted to detect a residual amount of the battery 27, and adapted to detect heat generated at the battery 27. Incidentally, the detection of the residual amount of the battery 27 is performed by monitoring a voltage of the battery 27.

The above-mentioned switch circuit 51 is electrically connected through the charge-controlling circuit 50 to the charging terminal 27a and is also electrically connected to the battery 27. The switch circuit 51 serves to switch a supply destination to which electric power from the battery 27 and the charger device 100 is supplied. When the charging is not performed, the switch circuit 51 is switched so as to allow electric power from the battery 27 to be supplied to a suspicious person-detecting section 60, whereas during the charging, the switch circuit 51 is switched so as to allow electric power supplied from the charger device to be supplied to the battery 27.

The above-mentioned suspicious person-detecting section 60 is comprised of a main control circuit 20 and a cleaning/security section 30. The main control circuit 20 comprises a CPU 21, a RAM 22 and a ROM 23, and is adapted to primarily control the above-mentioned charge-controlling circuit 50, switch circuit 51 and cleaning/security section 30, based on control programs and various parameter tables that are previously memorized in the ROM 23. The cleaning/security section 30 comprises various devices and circuits for facilitating performing of cleaning and detecting of a suspicious person. Incidentally, a construction of the cleaning/security section 30 will be discussed hereinafter with reference to FIG. 4.

In the self-propelled cleaner according to the present invention, the charging terminal 27a that is provided at the body BD is electrically connected through the charge-controlling circuit 50 and the switch circuit 51 to the battery 27 and is also electrically connected to the suspicious person-detecting section 60 that is comprised of the main control circuit 20 and the cleaning/security section 30. With this construction, when the self-propelled cleaner 10 is subjected to charging, electric power from the charger device 100 is supplied to the battery 27 and also supplied to the suspicious person-detecting section 60. Thus, the cleaning/security section 60 can perform the detection of a suspicious person even if the self-propelled cleaner is under charging.

FIG. 4 is a block diagram illustrating the construction of the cleaning/security section 30 shown in FIG. 3. As shown in FIG. 4, the cleaning/security section 30 includes the motor drivers 41R, 41L, the drive wheel motors 42R, 42L and an unshown gear unit arranged between the drive wheel motors 42R, 42L and the above-mentioned drive wheels 12R, 12L, as the above-mentioned driving mechanism. When the body is to be turn-traveled, rotational direction and rotation angle of the drive wheel motors 42R, 42L are particularly controlled by the motor drivers 41R, 41L. The respective motor drivers 41R, 41L are adapted to output driving signals corresponding to control signals from the CPU 21. Incidentally, as the gear unit and the drive wheels 12R, 12L, there may be employed various gear units and drive wheels. The driving of the body BD may be performed by causing round-shaped rubber tires to be driven or causing as endless belts to be traveled.

Furthermore, rotary encoders (not shown) are integrally attached to the drive wheel motors 42R, 42L. It is possible to detect actual rotational direction and rotation angle of the drive wheels from outputs of the rotary encoders. Incidentally, the rotary encoders may not be attached directly to the drive wheel motors 42R, 42 L and a freely rotatable driven wheel may be provided in the vicinity of the drive wheels. In this case, a rotating amount of the driven wheel is fed back, whereby an actual rotating amount of the drive wheels can be detected even if slipping of the drive wheels occurs. Furthermore, an acceleration sensor 44 detects accelerations in three XYZ-axial directions, and then outputs the detection results. The driving of the body BD may be performed by causing round-shaped rubber tires to be driven or causing as endless belts to be traveled.

The above-mentioned cleaner mechanism of the self-propelled cleaner 10 according to the present invention comprises the two side brushes 16 provided at the bottom of the body BD (see FIG. 2), the main brush 15 provided at the central portion of the bottom of the body BD (see FIG. 2), and a suction fan (not shown) for sucking dirt and/or dust swept by the main brush 15 and facilitating storing of the dirt and/or dust in a dust box. The main brush 15 is adapted to be driven by the main brush motor 52. Also, the suction fan is adapted to be driven by a suction motor 55. Motor drivers 54, 56 are adapted to supply driving power to the main brush motor 52 and the suction motor 55, respectively. The CPU 21 is adapted to suitably judge the cleaning performed by the main brush 15, according to a condition of the floor surface, a condition of the battery and instructions from the user, and then controls the cleaning.

Furthermore, the body BD is provided with the CCD camera 73. Image picking-up signals that are produced in the CCD camera 73 are sent through a bus 24 to the main control circuit 20, in which various processes are performed with respect to the image picking-up signals. The CCD camera 73 has an optical system that can pick up a forward image, and produces electric signals according to visible rays that are inputted from a sight that is realized by the optical system. Concretely, there are provided a plurality of photodiodes that are arranged correspondingly to respective picture elements at an image formation location that is determined by the above-mentioned optical system. The respective photodiodes produce electric signals that correspond to electrical energies of the inputted visible rays. A CCD element temporarily memorizes the electric signals that are produced for every picture elements, and produces image picking-up signals in which electric signals are continued for the respective picture elements. Then, the produced image picking-up signals are suitably outputted to the main control circuit 20.

Furthermore, the body BD is provided with the ultrasonic sensors 31 (31a-31g), the pyroelectric sensors 35 (35a-35d) serving as human sensors, and the step sensors 14 (see FIGS. 1 and 2). Furthermore, the body BD is provided with sidewall sensors 36R, 36L for detecting lateral walls of the room, as different sensors that are not shown in FIGS. 1 and 2. The sidewall sensors 36R, 36L may be comprised of, for example, passive sensors, ultrasonic sensors or the like. Furthermore, the body BD is provided with a gyro sensor 37, as one of the above-mentioned different sensors. The gyro sensor 37 comprises an angular velocity sensor 37a for detecting a change in an angular velocity that occurs due to change in the traveling direction of the body BD, and can detect an angle of a direction to which the body BD is directed, by multiplying a sensor output value detected by the angular velocity sensor 37a.

(3) The Operation of the Self-Propelled Cleaner:

Now, the operation of the self-propelled cleaner 10 according to the present invention will be discussed hereinafter.

The self-propelled cleaner 10 according to the present invention is constructed so as to be capable of carrying out cleaning while automatically traveling, according to the control programs previously memorized in the ROM 23. When unevenness of a wall or floor surface is detected by the sensors during the cleaning by the cleaner having automatically traveled, the traveling of the cleaner is controlled on the basis of the above-mentioned control programs.

Furthermore, the self-propelled cleaner 10 according to the present invention is constructed so as to conduct a homing control, which makes the body BD automatically travel to the charger device 100 set on the wall and then makes the charging terminal 27a operatively connect to the electrical supply terminal 101 of the charger device 100, thereby performing charging, when the residual amount of the battery 27 is decreased while the cleaner performs the cleaning while self-traveling.

Furthermore, as described above, the self-propelled cleaner according to the present invention is constructed such that the suspicious person-detecting section 60 is operated and detects a suspicious person even if the self-propelled cleaner is under charging.

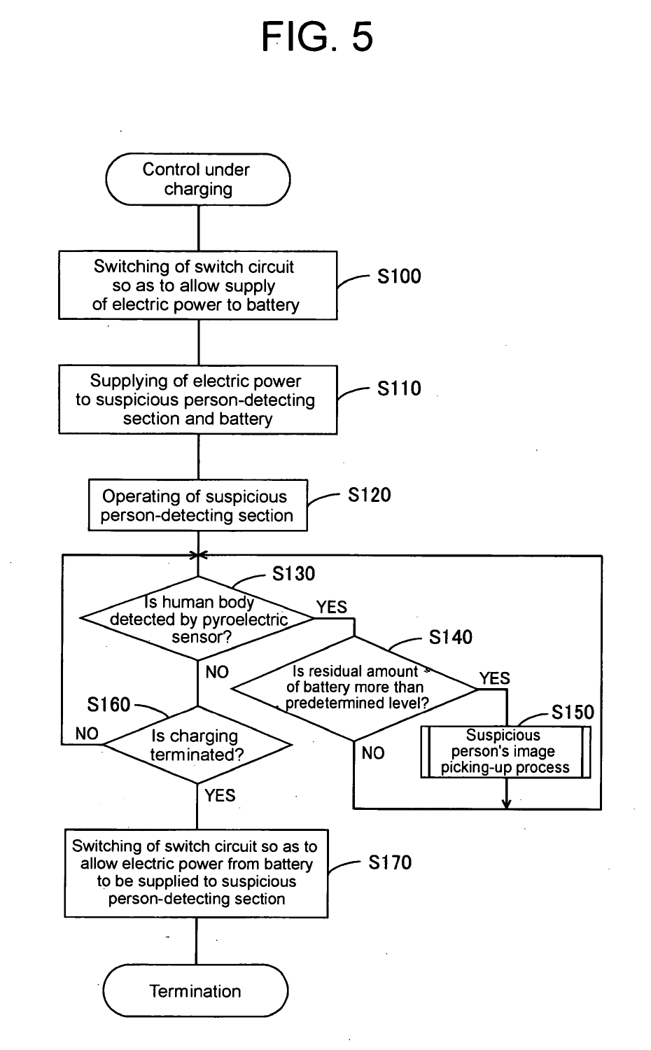

A control process during charging that is performed in the self-propelled cleaner 10 according to the present invention will described hereinafter with reference to a flowchart shown in FIG. 5. This control process during charging is initiated when the above-mentioned homing process is performed and it is detected that the charging terminal 27a on the side of the self-propelled cleaner 10 has been operatively connected to the electrical supply terminal 101 on the side of the charger device 100. When the control process during charging is initiated, first of all the switch circuit is switched so as to allow electric power to be supplied to the battery at a step S100. In this process, the electric power supplied through the charging terminal 27a from the charger device 100 is supplied to the battery 27 and the switch circuit 51 is switched so as not to allow the electric power to be supplied to the suspicious person-detecting section 60.

After the process at the step S100 is completed, supplying of electric power to the suspicious person-detecting section and the battery is carried out at a step S110. In this process, the electric power supplied from the charger device 100 is supplied through the charging terminal 27a to the battery 27 and the suspicious person-detecting section 60. By performing of this process, it is possible to supply the electric power to the suspicious person-detecting section 60 while charging the battery 27, and it is possible to perform the detection of a suspicious person simultaneously with the charging.

After the process at the step S110 is completed, operating of the suspicious person-detecting section is performed at a step S120. In this process, each of pyroelectric sensors 35 (35a-35d) of the cleaning/security section 30 constituting the suspicious person-detecting section 60 is activated and then detects infrared rays generated from the human body. Incidentally, at this step S120, only the pyroelectric sensors 35 are operated and other devices constituting the cleaning/security section 30 are not operated.

After the process at the step S120 is completed, whether or not the human body has been detected by the pyroelectric sensors is judged at a step S130. In this process, whether or not infrared rays generated from the human body have been detected by any of the four pyroelectric sensors 35 (35a-35d) is judged. When it is judged at the step S130 that the human body has not been detected, whether or not the charging has been terminated is judged at a step S160. In this process, whether or not the battery 27 has been perfectly charged is judged on the basis of detection signals of battery voltage that are supplied from the charge-controlling circuit 50. When it is judged at the step 160 that the charging has not been terminated yet, the process is returned to the step S130.

On the other hand, when it is judged at the step S130 that the human body has been detected, whether or not the residual amount of the battery 27 has been more than the predetermined level is judged at a step S140. In this process, whether or not the residual amount of the battery 27 has been more than the predetermined level is judged based on the detection signals of battery voltage that are supplied from the charge-controlling circuit 50. When it is judged at the step S140 that the residual amount of the battery 27 has been more than the predetermined level, a suspicious person's image picking-up process is performed at a step S150. While this process will be discussed in greater detail hereinafter, the process is a process for picking up an image of the human body having been detected by the pyroelectric sensors 35. Incidentally, the process at the above-mentioned step S140 is a process that is carried out prior to conducting of the process at the step S150 and in which whether or not electrical power enough to cause the body BB to travel and cause the CCD camera 73 to pick up an image has been left in the battery 27 is judged.

When the process at the step S150 should be performed or it is judged at the step S140 that the residual amount of the battery 27 has not exceeded the predetermined level (less than the predetermined level), the charging is continued. On the other hand, when it is judged at a step S160 that the charging has been completed, switching of the switch circuit so as to allow the electric power from the battery to be supplied to the suspicious person-detecting section is carried out at a step S170. In this process, supplying of electric power from the charger device 100 to the battery 27 is interrupted and the switch circuit 51 is switched so as to allow the electric power from the battery 27 to be supplied to the suspicious person-detecting section 60. Thus, the operation of the suspicious person-detecting section 60 is performed by the electric power supplied from the battery 27. After a process at a step S170 is performed, the control process during charging is finished.

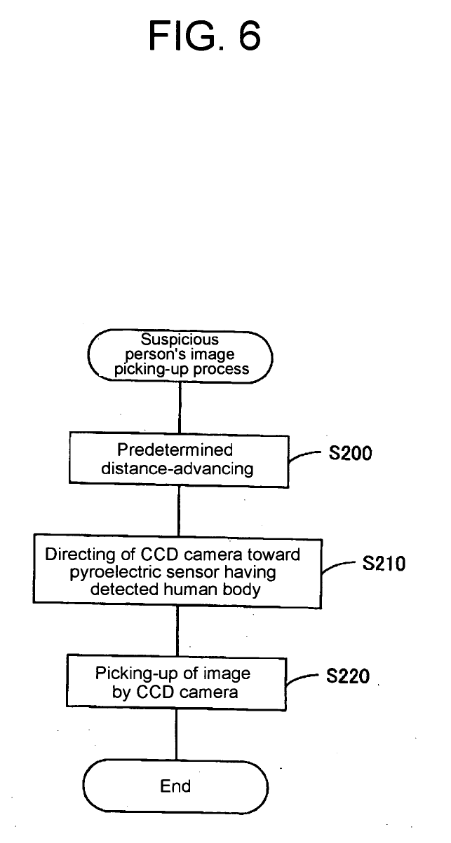

Now, the suspicious person's image picking-up process that is carried out according to a call at the step S150 in the flowchart shown in FIG. 6 will be discussed hereinafter. When the suspicious person's image picking-up process is initiated, first of all predetermined distance-ahead-traveling of the body BS is carried out at a step S200. By performing of this process, the body BD is moved forward by a predetermined distance from a position where the body BD is connected to the charger device 100, whereby the body BD is disconnected from the charger device 100.

Then, directing of the CCD camera to the pyroelectric sensor having detected the human body is performed in a step S210. In this process, the body BD is turned in such a manner that the CCD camera 73 is directed to any of the pyroelectric sensors that have detected the human body. By performing of this process, the human body having detected by the pyroelectric sensor 35 comes within an image picking-up range of the CCD camera 73. After this process is performed, picking-up of an image of the suspicious person is carried out by the CCD camera 73 at a step S220. Thus, the image of the human body (suspicious person) having been detected by the pyroelectric sensor 35 is picked up. Then, after the process at the step S220 is performed, the suspicious person's image picking-up process is terminated.

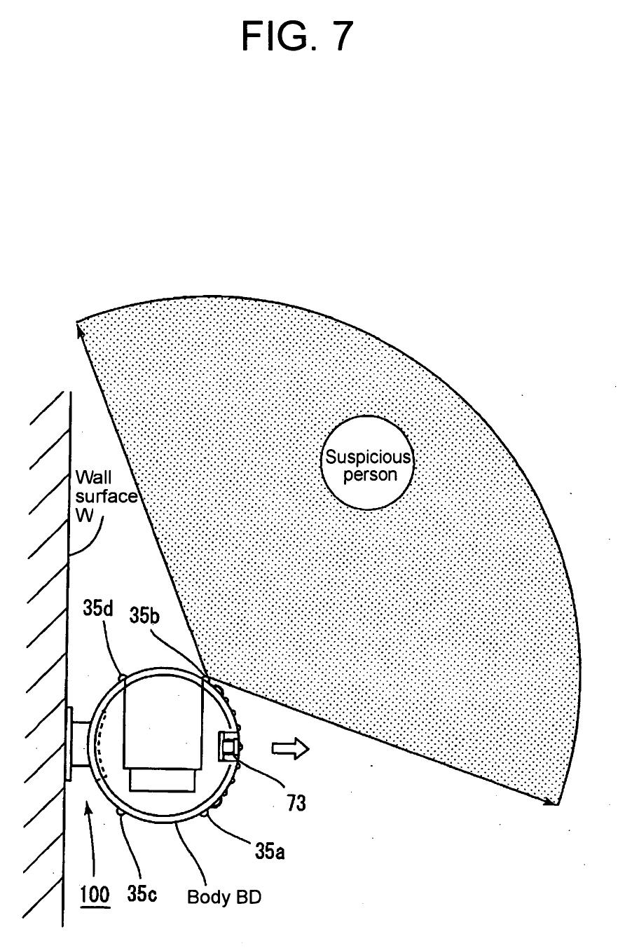

An embodiment that may be employed at the time when the processes shown in FIGS. 5 and 6 are performed will be discussed hereinafter with reference to FIGS. 7 to 9. When the connection between the charging terminal 27a on the side of the self-propelled cleaner 10 and the electrical supply terminal 101 on the side of the charger device 100 is made, the switching of the switch circuit 51 is performed in such a manner that the electric power from the charger device 100 is allowed to be supplied to the battery 27 (step S100), and the electric power from the charger device 100 is then supplied to both the battery 27 and the suspicious person-detecting section 60 (step S110). Thus, the suspicious person-detecting section 60 can detect a suspicious person even if the self-propelled cleaner is under charging.

Each of the pyroelectric sensors 35 (35a-35d) of the suspicious person-detecting section 60 is activated during the charging, whereby the detecting of infrared rays generated from the human body is performed (step S120), and when the human body is detected, the checking of the residual amount of the battery is carried out (step S140). Then, when it is judged that the residual amount of the battery has exceeded the predetermined level that is required in order to perform the picking-up of an image of the suspicious person later, the picking-up of the image of the suspicious person is carried out (step S150). FIG. 7 illustrates a state where the detection of the suspicious person has been carried out during the charging. As shown in FIG. 7, the body BD has been connected to the charger device 100 set on a wall W and has been subjected to charging. In this charging, the four pyroelectric sensors 35 (35a-35d) are all activated. When the human body comes within sensing areas of the pyroelectric sensors, they sense infrared rays generated from the human body. Also, FIG. 7 shows a state where the suspicious person has been detected by the pyroelectric sensor 35b of the four pyroelectric sensors 35.

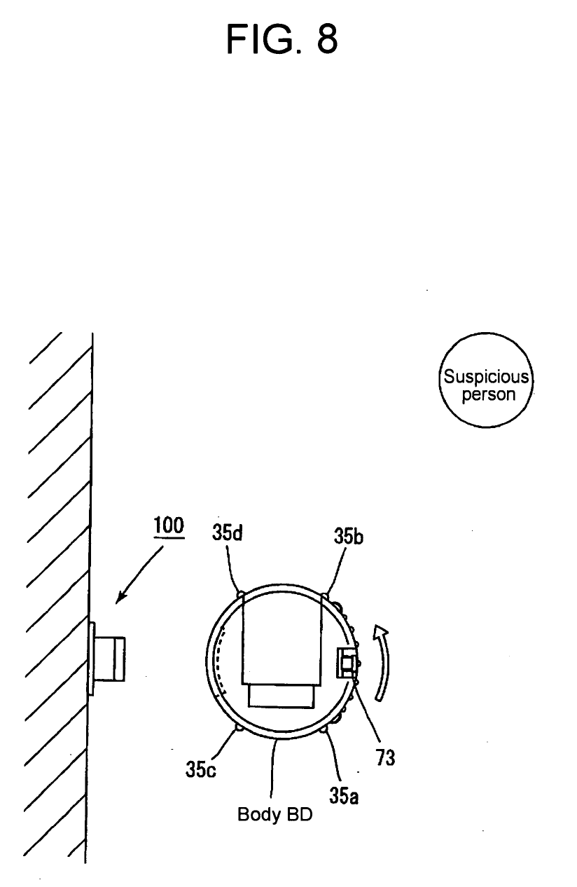

When the suspicious person has been detected by the pyroelectric sensors 35 and the residual amount of the battery 27 exceeds the predetermined level, the picking-up of the image of the suspicious person is carried out and first of all the body BD is advanced by the predetermined distance (step S200). By this process, the body BD is advanced by the predetermined distance in such a direction as to be indicated in FIG. 7 by a framed arrow. As a result, disconnecting of the body BD from the charger device 100 is performed as shown in FIG. 8.

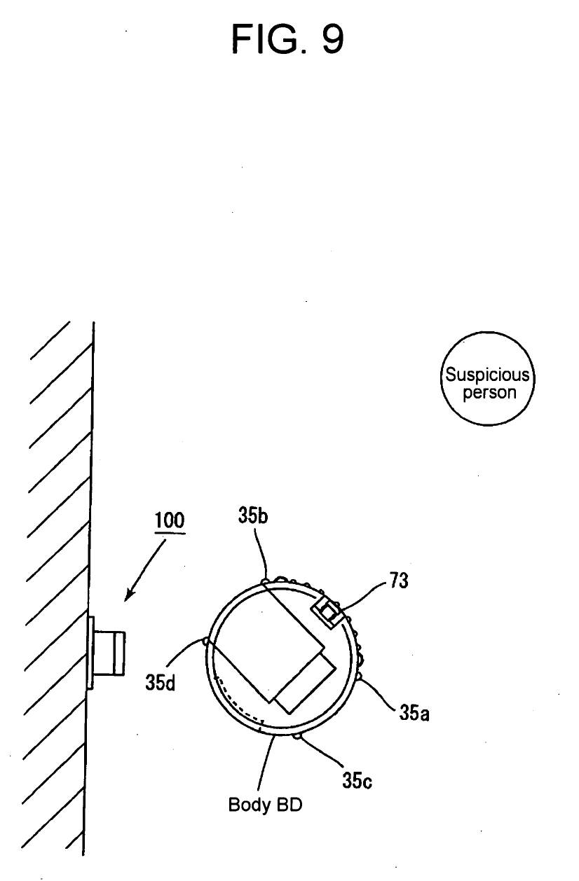

After the body BD is disconnected from the charger device 100, the body BD is turned in order that the picking-up of the image of the suspicious person can be performed and directing of the CCD camera 73 to a pyroelectric sensor 35 (the pyroelectric sensor 35b in the case shown in FIG. 7) having detected the human body is performed (step S210). In the case shown in FIG. 8, the human body has been detected by the pyroelectric sensor 35b. Therefore, the body BD is turned in the direction indicated in FIG. 8 by a framed arrow and, as shown in FIG. 9, an orientation of the CCD camera 73 is changed so as to be directed toward a position where the pyroelectric sensor 35b is set. Thus, the suspicious person comes within the image picking-up range of the CCD camera 73 and the picking-up of the image of the suspicious person is carried out (step S220). In this way, when the picking-up of the image of the suspicious person is to be performed by the CCD camera 73, the disconnecting of the body BD from the charger device 100 is once performed, to thereby cause the body BD to be separated from the charger device. Thus, it is possible to cause the body BD to be turned, and change the orientation of the CCD camera, so that the image picking-up range of the CCD camera that can pick up an image can be widened.

(4) Various Variants:

In the above-mentioned embodiment, when it is judged after the detecting of the human body by the pyroelectric sensor (human sensor) that the residual amount of the battery has been more than the predetermined level, the body BD is separated from the charger device, the orientation of the CCD camera is changed so as to be directed toward the pyroelectric sensor having detected the human body and the CCD camera then picks up the image of the suspicious person, whereas when it is judged that the residual amount of the battery has been less than the predetermined level, the picking-up of the image of the suspicious person is not performed. However, the present invention may be applied to a case where when the residual amount of the battery is less than the predetermined level, the picking-up of the image of the suspicious person is performed in a condition where the body remains connected to the charger device. In this case, the body BD is not separated from the charger device when the picking-up of the image of the suspicious person is to be performed, so that there is no possibility that the residual amount of the battery is consumed during the picking-up of the image of the suspicious person. Furthermore, the self-propelled cleaner may be such designed that when the suspicious person has been detected by the human sensor, predetermined warning (for example, warning by voice or light) is given to the suspicious person. In this case, when the suspicious person recognizes the warning and then approaches the self-propelled cleaner, the image of the suspicious person can be detected.

Furthermore, in the present invention, the CCD camera may be not necessarily provided as the above-mentioned camera. Furthermore, in lieu of the CCD camera, an infrared camera (for example, an infrared CCD camera or the like) that is adapted to catch infrared rays as rays to be picked up may be employed.

While the case where the travel device with the security function according to the present invention is the self-propelled cleaner provided with the cleaner mechanism in the illustrated embodiments is discussed above, the travel device to which the present invention may be applied is not limited to the self-propelled cleaner. The travel device may not be provided with the cleaner mechanism.

(5) Summary

As described above, in the self-propelled cleaner 10 according to the embodiments of the present invention, when the charging of the battery is performed, electric power supplied from the charger device 100 is supplied to both the buttery 27 and the suspicious person-detecting section 60, the four pyroelectric sensors 35 (35a-35b) of the suspicious person-detecting section 60 are activated during the charging of the battery 27, and a suspicious person is then detected, so that it is possible to detect a suspicious person during charging and it is therefore possible to always monitor the suspicious person.

It should be noted that the terms and expressions having been employed herein are used as terms of description, not of limitation. In the use of such terms and expressions, there is no intention of excluding any equivalents of the features illustrated and described or portions thereof. However, it is recognized that various modifications are possible within the scope of the invention claimed.

We claim:

1. A self-propelled cleaner with a security function, comprising:
a driving mechanism responsible for steering and driving of said self-propelled cleaner;
a cleaner mechanism;
a human sensor;
a suspicious person-detecting section for detecting a suspicious person;
a camera capable of picking up an image of the suspicious person;
a battery for supplying electric power to said driving mechanism and said suspicious person-detecting section;
said battery being adapted to be charged by an external charger device; wherein when said battery is charged, electric power supplied from said charger device is adapted to be supplied to both said battery and said suspicious person-detecting section, whereby said suspicious person-detecting section is activated under charging of said battery;
a battery monitoring-section for detecting a residual amount of said battery; wherein when said suspicious person-detecting section detects the suspicious person during the charging of said battery and said residual amount of said battery that is detected by said battery monitoring-section exceeds a predetermined level, said self-propelled cleaner is adapted to be traveled so as to be operatively separated from said charger device and is then drive-controlled so as to be turned so that said suspicious person comes within an image picking-up range of said camera; and
a suspicious person's image picking-up section for performing picking-up of an image of the suspicious person having been detected by said camera.

2. A travel device with a security function, comprising:
a driving mechanism responsible for steering and driving of said travel device;
a suspicious person-detecting section for detecting a suspicious person; and
a battery for supplying electric power to said driving mechanism and said suspicious person-detecting section;
said battery being adapted to be charged by an external charger device; wherein when said battery is charged, electric power supplied from said charger device is adapted to be supplied to both said battery and said suspicious person-detecting section, and said suspicious person-detecting section is activated under the charging of said battery.

3. A travel device with a security function according to claim 2, wherein said suspicious person-detecting section comprises a human sensor.

4. A travel device with a security function according to claim 2, including a camera that can pick up an image of said suspicious person.

5. A travel device with a security function according to claim 4, including a suspicious person's image picking-up section for picking up an image of a suspicious person, said suspicious person's image picking-up section including said camera, wherein when the suspicious person has been detected by said suspicious person-detecting section during the charging of said battery, said travel device is adapted to be traveled so as to be operatively separated from said charger device, and said travel device is adapted to be then drive-controlled so as to be turned so that the suspicious person comes within an image picking-up range of said camera, and said suspicious person's image picking-up section is adapted to perform picking-up of an image of the suspicious person by said camera.

6. A travel device with a security function according to claim 5, further including a battery monitoring-section for detecting a residual amount of said battery, wherein when said residual amount of said battery that has been detected by said battery monitoring-section exceeds a predetermined level, said suspicious person's image picking-up section is adapted to be activated.

7. A travel device with a security function according to claim 2, further including a cleaner mechanism.

8. A travel device with a security function according to claim 2, wherein said human sensor comprises pyroelectric sensors that sense infrared rays generated from a human body and then detect a suspicious person who is present in the vicinity of a body of said travel device, wherein a detecting range around 360° of said body can be obtained by said pyroelectric sensors.

9. A travel device with a security function according to claim 2, including a charging terminal that is to be connected to said charger device, a charge-controlling circuit, said charging terminal being electrically connected to said charging terminal, and a switch circuit, said charge-controlling circuit being electrically connected to said battery through said switch circuit.

10. A travel device with a security function according to claim 6, wherein said battery monitoring-section is adapted to perform the detecting of said residual amount of said battery by monitoring a voltage of said battery.

11. A travel device with a security function according to claim 9, wherein said switch circuit serves as means to switch a destination to which electric power supplied from said battery and said charger device is supplied, and wherein when said travel device is not subjected to charging, said switch circuit is switched so as to allow the electric power from said battery to be supplied to said suspicious person-detecting section, whereas when said travel device has been subjected to charging, said switch circuit is switched so as to allow the electric power from said charger device to be supplied to said battery.

12. A travel device with a security function according to claim 2, including a main control circuit, a CPU, a RAM, a ROM and a cleaning/security section, wherein operations of said charge-controlling circuit, switch circuit and cleaning/security section are adapted to be primarily controlled based on control programs and various parameter tables which are previously memorized in said ROM.

13. A travel device with a security function according to claim 12, wherein said driving mechanism comprises motor drivers, drive wheel motors, drive wheels and a gear unit arranged between said drive wheel motors and said drive wheels, wherein when said travel device is turn-traveled, said drive wheel motors are adapted to be particularly drive-controlled by said motor drivers in such a manner that rotational direction and rotation angle of said drive wheel motors are controlled, and each of said motor drivers is adapted to output driving signals corresponding to control instructions from said CPU.

14. A travel device with a security function according to claim 12, wherein said camera comprises an optical system that can pick up a forward image, and a CCD camera for producing electrical signals according to visible rays that are inputted from a sight that is realized by said optical system, wherein said CCD camera is adapted to also produce image picking-up signals that are sent through a bus to said main control circuit, and said main control circuit is adapted to perform processes with respect to said image picking-up signals.

15. A travel device with a security function according to claim 2, wherein when a residual amount of said battery is not more than a predetermined level, the charging of said battery is preferentially continued.
